(19) United States
(12) Patent Application Publication
(10) Pub. No.: US 2005/0039002 A1
(43) Pub. Date: Feb. 17, 2005

(54) Method, system and program product for protecting a distributed application user

(75) Inventors: Charles W. Kaufman, Northborough, MA (US); David J. Miller, Burlington, MA (US); Mary Ellen Zurko, Groton, MA (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/630,283

(22) Filed: Jul. 29, 2003

(51) Int. Cl. H04L 9/00

(52) U.S. Cl. 713/166

(57) ABSTRACT

Under the present invention, a (computer) user logs into a distributed application provided on a server. After authentication, a security value (e.g., a pseudo-random number) is generated for the user. The security value is stored at the server, and then sent to the user along with session information. Thereafter, the security value is associated with a set (e.g., one or more) of commands of the distributed application. When one of the set of commands is received from the user, the URL corresponding thereto is checked for the security value. If the value is present, the command is permitted. However, if the security value is not present, the command is not permitted and an error message is returned to the user.

### BACKGROUND OF THE INVENTION

1. Field of the Invention

In general, the present invention relates to a method, system and program product for protecting a distributed (e.g., web) application user. Specifically, the present invention protects a distributed application user by generating and associating a security value corresponding to the user with predetermined distributed application commands.

2. Related Art

As use of the computer networks such as the World Wide Web becomes more pervasive, a growing number of computer users are using distributed applications to perform computing functions. For example, today several web-based electronic mail applications exist that allow computer users to send and receive electronic mail messages using only a web browser. As known, a command in a web application is typically implemented using a Uniform Resource Locator (URL), which corresponds to a specific web address.

Unfortunately, as effective as URL-based commands can be, they can subject a user to a malicious attack on his/her computing resources. Specifically, using certain HTML formatting, a URL can be made to appear with innocuous looking text, when it actually has an underlying command that is entirely different. For example, a computer user might receive a URL in an electronic mail message that states “Click here for today's sports scores.” However, when the computer user selects the URL, the underlying command might actually delete all of the his/her electronic mail messages. This effect is commonly seen in viruses that propagate throughout the Internet. In one specific type of virus, an innocent appearing URL is communicated to a computer user in an electronic mail message. Upon selecting the URL, the same message is forwarded to all contacts in the computer user's address book. When one of the contacts selects the URL, the same thing happens. Because this causes a flood of electronic messages to be communicated, it often causes mails servers to crash. Accordingly, with an innocent appearing URL, the computer users have not only been subjected to a malicious attack, but also unwittingly participated in it.

This problem is compounded when content is sent to the computer user is not authenticated or signed, such as with “vanilla” electronic mail. In this scenario, it is often easy to imitate HTML mail from a trusted sender such as manager asking the user to follow an innocuous looking URL, which is actually a malicious command. If the user is already authenticated with their electronic mail application, there would be no indication he/she was issuing a malicious command, instead of simply bringing up an innocuous web page.

In view of the foregoing, there exists a need for a method, system and program product for protecting a distributed application user. Specifically, a need exists for a security value to be determined for an authenticated user of a distributed application. A further need exists for the security value to be associated with a set (e.g., one or more) of commands of the distributed application. Still yet, a need exists for a particular command received from the user to be checked for the security value. If the security value is not present, an additional need exists for the underlying command not to be executed and an error message returned to the user.

### SUMMARY OF THE INVENTION

In general, the present invention provides a method, system and program product for protecting a distributed (e.g., web) application user. Specifically, under the present invention, a (computer) user logs into a distributed application provided on a server. After authentication, a security value (e.g., a pseudo-random number) is generated for the user. The security value is stored at the server, and then sent to the user along with session information. Thereafter, the security value is associated with a set (e.g., one or more) of commands of the distributed application. That is, the security value is appended to a set of URLs corresponding to potentially dangerous commands of the distributed application. When one of the set of commands is received from the user, the URL corresponding thereto is checked for the security value. If the value is present, the command is permitted. However, if the security value is not present, the command is not permitted and an error message is returned to the user.

A first aspect of the present invention provides a method for protecting a distributed application user, comprising: providing a distributed application on a server; determining a security value for an authenticated user of the distributed application; associating the security value with a set of commands of the distributed application; receiving one of the set of commands on the server from the authenticated user; and checking the one command for the security value.

A second aspect of the present invention provides a method for protecting a distributed application user, comprising: providing a distributed application on a server; authenticating a user of the distributed application; determining, on the server, a security value for the authenticated user; associating the security value with a set of uniform resource locators (URLs) corresponding to a set of commands of the distributed application; communicating the security value to a client operated by the authenticated user; receiving one of the set of URLs on the server from the client; and checking the one URL for the security value.

A third aspect of the present invention provides a system for protecting a distributed application user, comprising: a security value system for determining a security value for an authenticated user of a distributed application provided on a server; an association system for associating the security value with a set of commands of the distributed application; and a command checking system for checking one of the set of commands received on the server from the authenticated user for the security value.

A fourth aspect of the present invention provides a program product stored on a recordable medium for protecting a distributed application user, which when executed, comprises: program code for determining a security value for an authenticated user of a distributed application provided on a server; program code for associating the security value with a set of commands of the distributed application; and program code for checking one of the set of commands received on the server from the authenticated user for the security value.

Therefore, the present invention provides a method, system and program product for protecting a distributed application user.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for protecting a distributed application user, according to the present invention.

FIG. 2 depicts a method flow diagram, according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system and program product for protecting a distributed (e.g., web) application user. Specifically, under the present invention, a (computer) user logs into a distributed application provided on a server. After authentication, a security value (e.g., a pseudo-random number) is generated for the user. The security value is stored at the server, and then sent to the user along with session information. Thereafter, the security value is associated with a set (e.g., one or more) of commands of the distributed application. That is, the security value is appended to a set of URLs corresponding to potentially dangerous commands of the distributed application. When one of the set of commands is received from the user, the URL corresponding thereto is checked for the security value. If the value is present, the command is permitted. However, if the security value is not present, the command is not permitted and an error message is returned to the user.

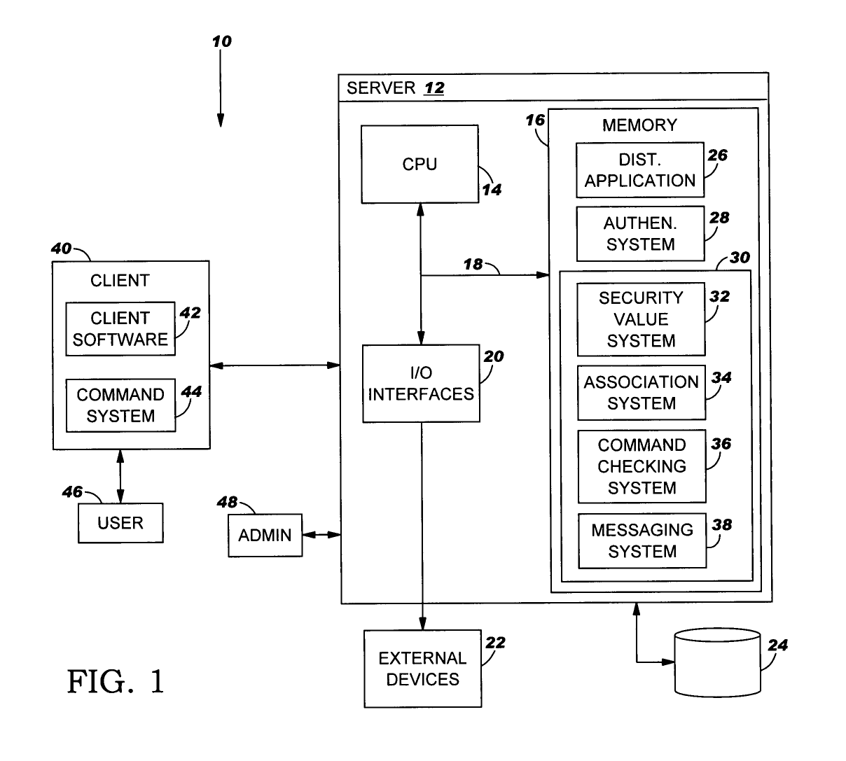

Referring to FIG. 1, system 10 for protecting a distributed application user 46 is shown. As depicted, system 10 includes server 12, which is in communication with one or more clients such as client 40. In general, communication between server 12 and client 40 occurs over a network in any known manner. For example, communication could occur via a direct hardwired connection (e.g., serial port) or via an addressable connection that may utilize any combination of wireline and/or wireless transmission methods. To this extent, while server 12 and client 40 are typically connected via the Internet, the teachings herein could be implemented in conjunction with any network-based application that is implemented over any type of network such as a wide area network (WAN), a local area network (LAN), a virtual private network (VPN) or other private network. In any event, server 12 and client 40 may utilize conventional network connectivity, such as Token Ring, Ethernet, WiFi or other conventional communications standards. Moreover, connectivity could be provided by conventional TCP/IP sockets-based protocol. In this instance, client 40 would utilize an Internet service provider to establish connectivity to server 12.

It should be understood that server 12 and client 40 are intended to represent any type of computerized systems capable of carrying out the functions of the present invention described herein. For example, client 40 and/or server 12 could be a personal computer, a workstation, a server, a laptop, a handhheld device, etc.

As shown, server 12 generally comprises central processing unit (CPU) 14, memory 16, bus 18, input/output (I/O) interfaces 20, external devices/resources 22 and storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LCD screen, hand-held device, keyboard, mouse, voice recognition system, speech output system, printer, monitor/display, facsimile, pager, etc. Bus 18 provides a communication link between each of the components in server 12 and likewise may comprise any known type of transmission link, including electrical, optical, wireless, etc.

Storage unit 24 can be any system (e.g., a database) capable of providing storage for information such as security values and session information under the present invention. As such, storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). It should be understood that although not shown, additional components, such as cache memory, communication systems, system software, etc., may be incorporated into server 12. Moreover, although not shown, client 40 will typically include computerized components (e.g., CPU, etc.) similar to server 12.

Shown in memory 16 of server 12 is distributed application 26, which is intended to represent any type of application that is implemented in a network environment. For example, distributed application 26 could be a web application implemented over the world wide web such as the electronic mail program HOTMAIL.COM. It should be understood, however, that the teachings described herein could be applied to any type of distributed or network-based application. In any event, also shown in memory are authentication system 28 and user protection system 30. In general, user protection system 30 protects user 46 from a malicious attack through distributed application 26. It should be appreciated that authentication system 28 and user protection system 30 are shown separately from distributed application 26 for illustrative purposes only. To this extent, authentication system 28 and/or one or more of the systems of user protection system 30 could be integrated within distributed application 26.

As further depicted, user 46 interacts with client 40, which includes client software 42 (e.g., a browser) and command system 44, to access distributed application 26. For example, assume that distributed application 26 is an electronic mail program that user 46 wishes to use to read his/her electronic mail messages. In this example, user 46 will use client software 42 to access the corresponding web page for distributed application 26. Once at the appropriate page, user 46 will be authenticated. Such authentication can occur by any known manner, and is not intended to be a limiting part of the present invention. For example, user 46 can input a user name and password, which will be communicated to server 12. Alternatively, authentication can occur via a smart card, biometric reading, etc. In any event, upon receipt, authentication system 28 will attempt to authenticate user 46. That is, authentication system 28 will compare the user name and password inputted by user 46 to a roster of authorized users of distributed application as stored in storage unit 24.

Once user 46 is authenticated, session information corresponding to the active session between user 46 and distributed application 26 is created. At this point, security value system 32 of user protection system 30 will generate a security value that corresponds to user 46 and the active session. In a typical embodiment, the security value is a cryptographically strong, pseudo-random number. To this extent, security value system 32 could include a random number generator. Once the security value has been generated it will be stored on server 12 in a cache and/or storage unit 24, and used for the remainder of the session. In addition, the security value can be communicated along with the session information to client 40 and stored in client software 42 (e.g., as a cookie, a Javascript variable, etc.). Under the present invention, the security value can remain the same and only refresh or change when the session times out and is re-established. Alternatively, a new security value could be generated for each interaction between client 40 and server 12. Still yet, there could be a time-based synchronization between distributed application 26 and client software 42.

In any event, under the present invention, association system 34 will associate the security value with a set (e.g., one or more) commands of distributed application 26. Specifically, association system 34 will associate (e.g., append) the security value to a set (e.g., one or more) of URLs corresponding to a set of commands. Typically, the security value is associated with any commands that: (1) are potentially dangerous for user 46; (2) require effort to undo; or (3) are difficult to reverse. For example, the security value could be associated with a command that would delete all of user 46's electronic mail messages. The commands with which the security value should be associated can be determined by an administrator 48, an application designer, or the like. For example, administrator 48 could program association system 34 with the specific commands with which the security value should be associated.

Once the security value has been associated with the set of web commands, user 46 can be protected. Specifically, any commands issued by user 46 will be associated with the security value. For example, when user 46 selects a button, icon or the like displayed in his/her browser to execute a web command, a particular URL will be transmitted to server 12 with the associated security value. Under the present invention, command checking system 36 will receive and analyze the particular URL. Specifically, command checking system 36 will first determine whether the particular URL should be associated with a security value (e.g., as indicated by administrator 48). If so, command checking system 36 will then check for the presence of the correct security value. Under the example set forth above, the particular URL should have user 46's security value appended thereto. Since the security value for user 46 was also stored on server 12 (e.g., in a cache or in storage unit 24), command checking system 36 can perform the comparison locally. If the security value is not present with the URL or is incorrect, the command would not be permitted and an error message would be generated and returned to user 46 via messaging system 38. The error message can prompt user 46 for confirmation before allowing the command to take place. Alternatively, if the command was not required to be associated with a security value, or if the security value was present and correct, the command would be permitted.

It should be understood that in receiving the particular URL from user 46, several scenarios are possible. For example, all URLs could be pre-constructed on server 12 and then sent to client 40. In this case, association system 34 will append the security value to all applicable URLs and send the same to client 40. When user 46 issues a command, the applicable URL and appended security value is retrieved from local memory and sent back to server 12. Alternatively, the URLs for the commands could be constructed on client 40 by client software 42 (e.g., via Javascript in DHTML). Under this scenario, command system 44 will extract the security value that was previously received with the session information, and append the security value to the constructed URL. If the URL is issued via a POST, the security value may be provided as a field in a form. Conversely, if the URL is issued via a GET, the URL syntax for embedding a parameter directly in the URL is used. In any event, client software 42 will communicate the URL and appended security value to server 12, where command checking system 36 will perform the above-described analysis.

As can be seen, the present invention prevents user 46 from selecting an innocent URL, and causing havoc on his/her own system. For example, assume user 46 receives an electronic mail message from a an outside sender, and the message includes an innocent appearing URL. Further assume that the underlying command is actually to delete all of user 46's electronic mail messages. Upon unsuspectingly selecting the URL, the delete command URL will be sent to server 12. However, because user 46 did not originate the command, it will not be associated with his/her security value. More specifically, because the command was not issued via the user interface constructed by distributed application 26, the command will not be associated with user 46's security value. Accordingly, command checking system 36 will not permit the underlying delete command to be automatically executed.

To further protect user 46, security should be maintained so that security values cannot be intercepted or otherwise misappropriated. For example, network cryptographic protocols such as Secure Sockets Layer (SSL) can be used to protect the security values from interception on the network. Moreover, using POSTs instead of GETs keep the security value out of the URL in a referrer field, if user 46 follows a URL to another web server from within the application context. In addition, user protection system 30 could be implemented as a filter servlet that is configured to intercept all requests intended for distributed application 26. This centralizes the security value checking, ensuring that there are no code paths that mistakenly do not check for the security value on commands that have been designated as needing protection under the present invention.

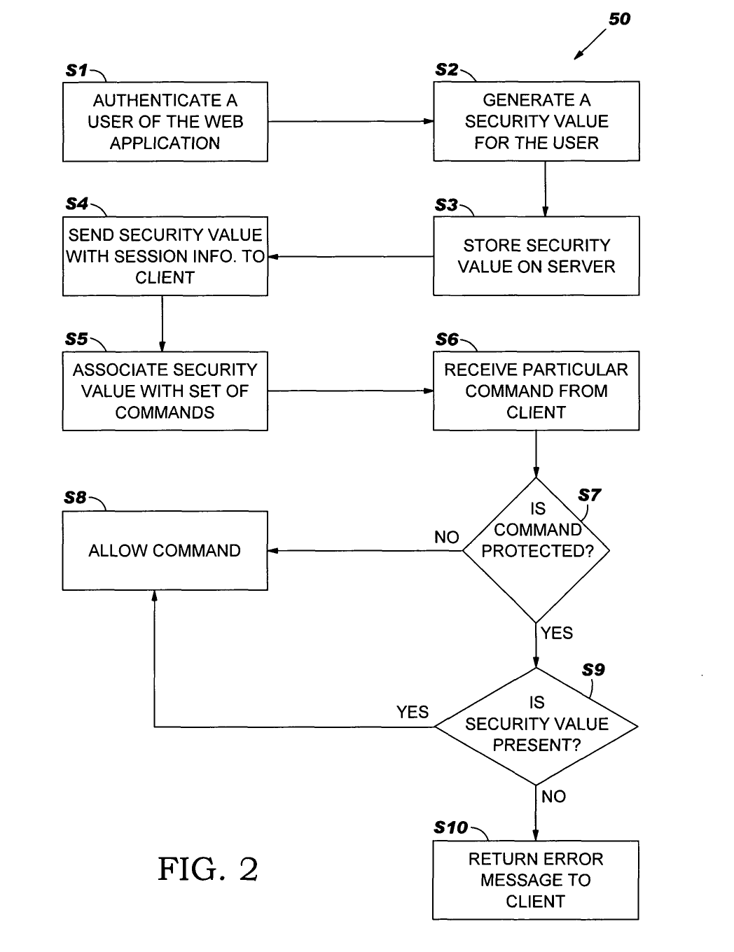

Referring now to FIG. 2, a method 50 flow diagram according to the present invention is shown. As depicted, first step S1 in method 50 is to authenticate a user of the distributed application. After authentication, second step S2 is to generate a security value for the user. Third step S3 is to store the security value on the server, and fourth step S4 is to send the security value with session information to the client that the user is operating. In fifth step S5, the security value is associated with a set of commands of the distributed application. Thereafter, when a command (possibly one of the set of commands) is received from the client in step S6, it is determined whether the command is a protected command in step S7. If the command is not protected, the command is allowed in step S8. If, however, the command is a protected command, it is checked for the security value in step S9. If the security value is present, the command is allowed in step S8. However, if the security value is not present, an error message is returned to the client in step S10.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for protecting a distributed application user, comprising
providing a distributed application on a server;
determining a security value for an authenticated user of the distributed application;
associating the security value with a set of commands of the distributed application;
receiving one of the set of commands on the server from the authenticated user; and
checking the one command for the security value.

2. The method of claim 1, further comprising returning an error message to the user if the security value is not found with the one command.

3. The method of claim 1, further comprising authenticating the user of the distributed application, prior to the determining step.

4. The method of claim 1, wherein the security value is a pseudo-random number.

5. The method of claim 1, further comprising storing the security value on the server.

6. The method of claim 1, further comprising:
associating the security value with session information corresponding to the authenticated user; and
communicating the session information and the security value to the authenticated user.

7. The method of claim 1, wherein the authenticated user operates a client that communicates with the server.

8. The method of claim 7, wherein the associating step comprises appending the security value to a set of uniform resource locators (URLs) that correspond to a set of commands of the distributed application, and wherein the receiving step comprises receiving one of the set of URLs on the server from the authenticated user.

9. The method of claim 8, wherein the one URL is pre-constructed on the server.

10. The method of claim 8, wherein the one URL is constructed on the client, and wherein the method further comprises:
extracting the security value on the client; and
appending the security value to the one URL on the client.

11. A method for protecting a distributed application user, comprising:
providing a distributed application on a server;
authenticating a user of the distributed application;
determining, on the server, a security value for the authenticated user;
associating the security value with a set of uniform resource locators (URLs) corresponding to a set of commands of the distributed application;
communicating the security value to a client operated by the authenticated user;
receiving one of the set of URLs on the server from the client; and
checking the one URL for the security value.

12. The method of claim 11, further comprising returning an error message to the client if the security value is not found with the one URL.

13. The method of claim 11, further comprising:
determining session information for the authenticated user; and
associating the security value with the session information, wherein the communicating step comprises sending the session information and the security value to a client operated by the user.

14. The method of claim 11, wherein the associating step comprises appending the security value to a set of URLs corresponding to a set of commands of the distributed application.

15. The method of claim 11, wherein the one URL is pre-constructed on the server, and wherein client receives the one URL and the associated security value from the server.

16. The method of claim 11, wherein the one URL is constructed on the client, and wherein the associating step comprises;
extracting the security value on the client; and
appending the security value to the one URL.

17. The method of claim 11, further comprising storing the security value on the server, prior to communicating the security value to the client.

18. A system for protecting a distributed application user, comprising:
a security value system for determining a security value for an authenticated user of a distributed application provided on a server;
an association system for associating the security value with a set of commands of the distributed application; and
a command checking system for checking one of the set of commands received on the server from the authenticated user for the security value.

19. The system of claim 18, further comprising a messaging system for returning a error message to the authenticated user if the security value is not found with the one command.

20. The system of claim 18, further comprising an authentication system for authenticating a user of the distributed application.

21. The system of claim 18, wherein the security value is a pseudo-random number.

22. The system of claim 18, wherein the security value is stored on the server.

23. The system of claim 18, wherein the security value is associated with session information corresponding to the authenticated user, and wherein the session information and the associated security value are communicated to the authenticated user.

24. The system of claim 18, wherein the command checking system comprises a filter servlet.

25. The system of claim 18, wherein the authenticated user operates a client that communicates with the server.

26. The system of claim 25, wherein the association system appends the security value to a set of uniform resource locators (URLs) that correspond to a set of commands of the distributed application, and wherein the command checking system checks one of the set of URLs received on the server from the authenticated user for the security value.

27. The system of claim 26, wherein the one URL is pre-constructed on the server.

28. The system of claim 26, wherein the one URL is constructed on the client, and wherein the client comprises a command system for extracting the security value on the client, and for appending the security value to the one URL.

29. A program product stored on a recordable medium for protecting a distributed application user, which when executed, comprises:
program code for determining a security value for an authenticated user of a distributed application provided on a server;
program code for associating the security value with a set of commands of the distributed application; and
program code for checking one of the set of commands received on the server from the authenticated user for the security value.

30. The program product of claim 29, further comprising program code for returning a error message to the authenticated user if the security value is not found with the one command.

31. The program product of claim 29, further comprising program code for authenticating a user of the distributed application.

32. The program product of claim 29, wherein the security value is a pseudo-random number.

33. The program product of claim 29, wherein the security value is stored on the server.

34. The program product of claim 29, wherein the security value is associated with session information corresponding to the authenticated user, and wherein the session information and the associated security value are communicated to the authenticated user.

35. The program product of claim 29, wherein the program code for checking comprises a filter servlet.

36. The program product of claim 29, wherein the authenticated user operates a client that communicates with the server.

37. The program product of claim 36, wherein the program code for associating appends the security value to a set of uniform resource locators (URLs) that correspond to a set of commands of the distributed application, and wherein the program code for checking checks one of the set of URLs received on the server from the authenticated user for the security value.

38. The program product of claim 37, wherein the one URL is pre-constructed on the server.

39. The program product of claim 37, wherein the one URL is constructed on the client, and wherein the client comprises a program code for extracting the security value on the client, and for appending the security value to the one URL.
